(19) United States
(12) Patent Application Publication
(10) Pub. No.: US 2024/0376264 A1
(43) Pub. Date: Nov. 14, 2024

(54) FLAME RETARDANT POLYAMIDE COMPOSITIONS, USES OF SAME AND PROCESSES FOR THE PREPARATION THEREOF

(71) Applicant: ARKEMA FRANCE, COLOMBES (FR)

(72) Inventors: Thibaut SAVART, Lacq (FR); Lise DEVES, Serquigny (FR); Jean-Jacques FLAT, Serquigny (FR); Florent ABGRALL, Serquigny (FR)

(73) Assignee: ARKEMA FRANCE, COLOMBES (FR)

(21) Appl. No.: 18/286,048

(22) PCT Filed: Mar. 31, 2022
(86) PCT No.: PCT/FR2022/050607

§ 371 Date: Oct. 6, 2023

(30) Foreign Application Priority Data
Apr. 8, 2021 (FR) FR2103584

(51) Int. Cl. C08G 69/26; C08G 69/28; C08G 69/36; C08J 5/24

(52) U.S. Cl. CPC C08G 69/265; C08G 69/28; C08G 69/36; C08J 5/24; C08G 2250/00; C08J 2377/06

(57) ABSTRACT

A composition for a thermoplastic composite material including: a) from 65% to 95% by weight of at least one reactive semicrystalline polyamide prepolymer with an average molar mass Mn of less than 5000 g/mol and having a volume-mean diameter D50 of the reactive semicrystalline polyamide prepolymer powder particles ranging from 10 to 300 μm, b) from 5% to 35% by weight of at least one flame retardant chosen from an at least partially meltable flame retardant in powder form and having a volume-mean diameter D50 of from 10 to 300 μm, and a non-meltable flame retardant in premilled powder form with a volume-mean diameter D50 of from 1 to 50 μm, and c) from 0 to 2% by weight of at least one additive, and said reactive polyamide prepolymer comprising or consisting of at least one Z/BACT/XT copolyamide.

### TECHNICAL FIELD

The present patent application relates to flame-retardant reactive compositions of polyamide, to the uses thereof for the preparation of a flame-retardant composite fibrous material, and to the process for preparing said flame-retardant composite fibrous material.

### PRIOR ART

The use of materials such as polyamides has grown considerably in the last ten years. These materials often aim to replace parts initially made of metal, thus resulting in considerable lightening of the article thus modified. However, it turned out that, in certain fields, little use was made of these materials, due to their excessively high flammability.

For example, in the transport sector, and more particularly the aviation sector, the requisite standards in terms of flammability are draconian. The airworthiness regulations impose specific flammability tests. Specifically, materials that are too readily flammable cannot be tolerated within a vehicle such as an aircraft.

Furthermore, it is also sought, notably in the transport sector, to lighten the structures as much as possible, even those that are already made of plastic materials, so as to reduce the fuel consumption costs and limit the ecological footprint associated with this fuel consumption.

International patent application WO 2016/124766 describes flame-retardant polyamide compositions comprising at least one polyamide, at least one melamine derivative, optionally at least one polyol comprising at least four alcohol functions, and optionally at least one reinforcement in the form of a fiber. The compositions according to said invention may not be suitable for the preparation of composite materials, due to their excessively high viscosity and therefore incompatible with the core impregnation requirements of fibrous materials.

Also, in the case of composites and when flame retardants that are solid at room temperature are used, the polyamide composition containing flame retardants must be able to impregnate the fibers suitably; as a result, it is essential that the size of the flame retardant particles is not too large, in particular with a volume D50 of less than or equal to 50 μm for unmeltable flame retardants, and that if the impregnation method envisaged is a fluidized bed, the physiochemical properties (notably the density) of the flame retardants allow them to be fluidized and distributed homogeneously with the polymer powder in the fluidized bed. If the flame retardant particles are unmeltable at the processing temperature of the composites, it is also necessary for the size of the flame retardant particles to be as small as possible, in particular with a mean particle diameter close to the dimension (diameter) of the reinforcing fibers of the composite, i.e. generally between 1 and 50 μm.

Consequently, there is a real need to propose compositions based on polyamide, notably semiaromatic polyamide, with good properties in terms of flammability and ease of processing, in particular at a temperature of less than 320° C., and which are notably suitable for the manufacture of impregnated thermoplastic materials reinforced with long or continuous fibers, which are lightened in terms of weight and notably suitable for use in the transport sector, in particular for aviation.

Moreover, a flame-retardant polyamide composition must also have high mechanical performance, notably high stiffness above 80° C., preferably 100° C., even in the wet state. These various problems are solved by the present invention, which relates to a flame-retardant reactive composition for a flame-retardant thermoplastic composite material comprising:
a) from 65% to 95% by weight of at least one reactive semicrystalline polyamide prepolymer with an average molar mass Mn of less than 5000 g/mol and having a volume-mean diameter D50 of the reactive semicrystalline polyamide prepolymer powder particles of from 10 to 300 μm, notably from 30 to 200 μm, more particularly from 45 to 200 μm,
b) from 5% to 35% by weight of at least one flame retardant chosen from an at least partially meltable flame retardant in powder form and having a volume-mean diameter D50 of from 10 to 300 μm, notably from 10 to 200 μm, more particularly from 10 to 150 μm and a non-meltable flame retardant in premilled powder form and having a volume-mean diameter D50 of from 1 to 50 μm, notably from 10 to 50 μm, more particularly from 15 to 25 μm, and
c) from 0% to 2% by weight of at least one additive and having a volume-mean diameter D50 of from 1 to 50 μm if it is non-meltable or from 10 to 300 μm if it is meltable,
said composition being obtained by dry blending of the various constituents a), b) and c),
and said reactive polyamide prepolymer comprising or consisting of at least one Z/BACT/XT copolyamide in which:
BACT is a unit bearing an amide unit present in a molar content ranging from 10% to 65%, preferably from 10% to 60%, where BAC is 1,3-bis (aminomethyl) cyclohexyl (1,3-BAC), and T is terephthalic acid,
XT is a unit bearing an amide unit present in a molar content ranging from 30% to 60%, preferably from 35% to 55%, where X is a linear aliphatic C4 to C18 and preferably C5 to C12 diamine, in particular chosen from C5, C6, C9, C10 and C12 and where T is terephthalic acid,
Z is a unit bearing an amide unit present in a molar content ranging from 5% to 30%, preferentially from 10% to 25%, and resulting:
from the condensation of at least one C6-C14 amino acid or lactam, or
from the condensation of a diamine and of a diacid X1Y, X1 and Y being of C4-C18, in particular C10-C12,
the molar sum Z +BACT +XT being equal to 100%, and the sum of constituents a)+b)+c) being equal to 100% by weight,
said reactive semicrystalline polyamide prepolymer having a melting temperature Tf<300° C., preferably <285°° C., more preferentially <280° C., as determined according to the standard ISO 11357-3:2013, a glass transition temperature Tg>80° C., preferably >100° C., more preferentially >120° C., determined according to the standard ISO 11357-2:2013 and a difference between the melting temperature and the crystallization temperature Tf−Tc<70° C., preferably <65° C., more preferentially <60° C., determined according to the standard ISO 11357-3:2013.

The Inventors have thus found, unexpectedly, that the use of a flame retardant in a composition based on semi-aromatic polyamide, said flame retardant being at least partially meltable in powder form having a particular volume-mean diameter D50 range or non-meltable in premilled powder form and having a particular volume-mean diameter D50 range, allows compositions to be obtained which have good properties in terms of flammability and ease of processing, in particular at temperatures of less than 300-320° C., while at the same time displaying high mechanical performance, notably high rigidity above 80° C., preferably 100° C., even in the wet state, and suitable for the manufacture of flame-retardant thermoplastic composite materials such as impregnated thermoplastic materials reinforced with long or continuous fibers, which are lightened in terms of weight and notably suitable for use in the transport sector, in particular for aviation, flying vehicles in general, new mobility and the railway sector.

The expression “reactive composition” means that the composition comprises a reactive semicrystalline polyamide prepolymer.

The expression “reactive semicrystalline polyamide prepolymer” means that the molecular weight Mn of said reactive semicrystalline polyamide prepolymer will change during its subsequent use by reaction of reactive semicrystalline polyamide prepolymers with each other by polycondensation with the release of water or by substitution or by reaction of reactive prepolymers with a chain extender by polyaddition and without elimination of volatile byproducts to subsequently lead, after use, to the final nonreactive semicrystalline polyamide polymer of the thermoplastic matrix.

The expression “final nonreactive semicrystalline polyamide polymer” means that the final semicrystalline polyamide polymer has a molecular weight that is no longer likely to change significantly, that is, its number-average molecular mass (Mn) changes by less than 50% when it is processed and therefore corresponds to the final polymer of the thermoplastic matrix.

The Mn is determined in particular by calculation from the content of terminal functions determined by potentiometric titration in solution and the functionality of said prepolymers or by NMR assay (Postma et al. (Polymer, 47, 1899-1911 (2006)), preferentially by titration.

### As Regards the Reactive Semicrystalline Polyamide Prepolymer

A semicrystalline polyamide prepolymer, for the purposes of the invention, denotes a polyamide prepolymer which has a glass transition temperature determined by dynamic mechanical analysis (DSC) according to the standard ISO 11357-2:2013 and a melting temperature (Tf) determined according to the standard ISO 11357-3:2013.

Said reactive semicrystalline polyamide prepolymer has a melting temperature Tf<300° C., preferably <285° C., more preferentially <280° C., as determined according to the standard ISO 11357-3:2013, a glass transition temperature Tg>80° C., preferably >100° C., more preferentially >120° C., determined according to the standard ISO 11357-2:2013 and a difference between the melting temperature and the crystallization temperature Tf−Tc<70° C., preferentially <65° C., more preferentially <60° C., determined according to the standard ISO 11357-3:2013.

Said semicrystalline polyamide prepolymer has a volume-mean diameter D50 of the reactive semicrystalline polyamide prepolymer powder particles ranging from 10 to 300 um, notably from 30 to 200 μm, more particularly from 45 to 200 μm.

Advantageously, the volume diameter D90 of the reactive semicrystalline polyamide prepolymer powder particles is from 30 to 500 μm, advantageously from 80 to 300 μm.

Advantageously, the volume diameter D10 of the reactive semicrystalline polyamide prepolymer powder particles is from 5 to 200 μm, advantageously from 15 to 100 μm.

Advantageously, the volume diameter of the reactive semicrystalline polyamide prepolymer powder particles is within the ratio D90/D10, i.e. from 1.5 to 50, advantageously from 2 to 10.

The volume diameters of the particles (D10, D50 and D90) are defined according to the standard ISO 9276:2014.

“D50” corresponds to the volume-mean diameter, that is to say the particle size value which divides the population of particles examined exactly into two.

“D90” corresponds to the value at 90% of the cumulative curve of the volume particle size distribution.

“D10” corresponds to the size of 10% of the volume of the particles.

Advantageously, the semicrystalline polyamide prepolymer displays a second-heating crystallization enthalpy during the cooling step at a rate of 20 K/min in DSC measured according to the standard ISO 11357-3 of 2013 of greater than 25 J/g, preferably greater than 30 J/g, more preferentially greater than 40 J/g.

The number-average molar mass (Mn) of said reactive semicrystalline polyamide prepolymer is less than 5000 g/mol.

Advantageously, said number-average molar mass (Mn) ranges from 500 g/mol to 5000 g/mol, preferably from 1000 g/mol to less than 5000 g/mol, more preferentially from 2000 g/mol to less than 5000 g/mol, even more preferentially from 3000 g/mol to less than 5000 g/mol.

The number-average molar mass Mn of said final nonreactive semicrystalline polyamide polymer is greater than or equal to 8000 g/mol, preferentially within a range extending from 10 000 g/mol to 40 000 g/mol, preferably from 12 000 g/mol to 30 000 g/mol.

Said reactive polyamide prepolymer comprises or consists of at least one Z/BACT/XT copolyamide.

When said prepolymer comprises at least one Z/BACT/XT copolyamide, said at least one Z/BACT/XT copolyamide is predominantly present, i.e. it is present to at least 50% by weight relative to the total weight of reactive polyamide prepolymer.

Advantageously, it is present to at least 60% by weight relative to the total weight of reactive polyamide prepolymer.

More advantageously, it is present to at least 70% by weight relative to the total weight of reactive polyamide prepolymer.

Even more advantageously, it is present to at least 80% by weight relative to the total weight of reactive polyamide prepolymer.

In particular, it is present to at least 90% by weight relative to the total weight of reactive polyamide prepolymer.

When said prepolymer consists of at least one Z/BACT/XT copolyamide, then it represents 100% by weight relative to the total weight of reactive polyamide prepolymer.

Said Z/BACT/XT copolyamide consists of three units bearing an amide unit: Z, BACT and XT.

In one embodiment, said reactive semicrystalline polyamide prepolymer comprises at least two polyamide prepolymers which are reactive with each other and which each respectively bear two identical end functions X′ or Y′, said function X′ of one prepolymer being able to react only with said function Y′ of the other prepolymer, in particular by condensation, more particularly with X′ and Y′ being amine and carboxyl or carboxyl and amine, respectively.

Said reactive prepolymers are prepared by conventional polycondensation reaction between the diamine and corresponding diacid components and (depending on the unit Z) amino acids or lactams, while respecting the nature and proportions of the BACT and XT and Z units according to the invention. The prepolymers bearing amine and carboxyl functions X′ and Y′ on the same chain may be obtained, for example, by adding a combination of monomers (amino acid, diamine, diacid) having in total an equal amount of amine and carboxyl units. Another route for obtaining these prepolymers bearing an X′ function and a Y′ is, for example, by combining a prepolymer bearing two identical X′=amine functions with a diacid prepolymer bearing Y′=carboxyl, with an overall molar content of acid functions equal to that of the starting amine functions X′.

In order to obtain prepolymers functionalized with identical (amine or carboxyl) functions on the same chain, it is sufficient to have an excess of diamine (or of amine functions overall) in order to have amine end functions or an excess of diacid (or of carboxyl functions overall) in order to have carboxyl end functions.

In another embodiment, said reactive semicrystalline polyamide prepolymer comprises or consists of:
a1) at least one prepolymer of said thermoplastic polyamide polymer, bearing n end reactive functions X′, chosen from: —NH2, —CO2H and —OH, preferably NH2 and —CO2H, with n being from 1 to 3, preferably from 1 to 2, more preferentially 1 or 2, more particularly 2
a2) at least one chain extender Y—A′—Y, with A′ being a hydrocarbon-based biradical of nonpolymeric structure, bearing two identical end reactive functions Y, which are reactive by polyaddition with at least one function X′ of said prepolymer a1), preferably with a molecular mass of less than or equal to 500 and more preferentially less than or equal to 400.

In the preceding embodiment, X′ may be NH2 or OH, in particular NH2, and Y is chosen from an anhydride, a maleimide, an optionally blocked isocyanate, an oxazinone, an oxazolinone and an epoxy, and notably from an anhydride, in particular 3,3′,4,4′-benzophenonetetracarboxylic dianhydride, an oxazinone, an oxazolinone and an epoxy.

Advantageously, said reactive semicrystalline polyamide prepolymer a1) is at least one amino prepolymer (bearing-NH2) of said semicrystalline polyamide polymer of the thermoplastic matrix, in particular with at least 50% and more particularly with 100% of the end groups of said prepolymer a1) being primary amine functions —NH2, and a2) at least one nonpolymeric chain extender bearing a cyclic carboxylic anhydride group, preferably borne by an aromatic ring, having as substituent a group comprising an ethylenic or acetylenic unsaturation, preferably acetylenic unsaturation, said carboxylic anhydride group possibly being in acid, ester, amide or imide form with said extender a2) being present in a content corresponding to an a2)/(—NH2) mole ratio of less than 0.36, preferably ranging from 0.1 to 0.35, more preferentially ranging from 0.15 to 0.35 and even more preferentially ranging from 0.15 to 0.31, and in that said thermoplastic polymer of the matrix is the product of the polymerization reaction by extension of said prepolymer a1) with said extender a2).

More advantageously, said extender a2) is chosen from aromatic anhydride compounds, preferably o-phthalic anhydride compounds, substituted in position 4 of the aromatic ring with a substituent defined by a group R—C═C—(R′)x— with R being a C1-C2 alkyl or H or aryl, in particular phenyl, or R is the residue of an aromatic carboxylic anhydride, preferably o-phthalic anhydride, bonded to the acetylenic triple bond via the carbon in position 4 of the aromatic ring and x being equal to 0 or to 1, and when x is equal to 1, R′ is a carbonyl group.

In particular, said extender a2) is chosen from o-phthalic aromatic anhydride compounds bearing, in position 4, a substituent group chosen from methyl ethynyl, phenyl ethynyl, 4-(o-phthaloyl) ethynyl or phenyl ethynyl ketone, also called (phenylethynyl) trimellitic anhydride, and preferably bearing, in position 4, a substituent group chosen from methyl ethynyl and phenyl ethynyl ketone.

In one embodiment, said extender a2) defined above has a molecular weight less than or equal to 500, preferably less than or equal to 400.

In another embodiment, X′ may also be CO2H and Y is chosen from an epoxy, an oxazoline, an oxazine, an imidazoline and an aziridine, such as 1,1′-iso- or terephthaloyl bis (2-methylaziridine), notably an epoxy and an oxazoline.

Advantageously, X′ is CO2H and Y—A′—Y is chosen from phenylenebisoxazolines, preferably 1,3-phenylenebis (2-oxazoline) or 1,4-phenylenebis (2-oxazoline) (PBO).

As examples of chain extenders bearing oxazoline or oxazine reactive functions Y that are suitable for use in the invention, reference may be made to those described under references “A”, “B”, “C” and “D” on page 7 of patent application EP 0 581 642, and also to the processes for preparing same and the modes of reaction thereof which are disclosed therein. “A” in said document is bisoxazoline, “B” is bisoxazine, “C” is 1,3-phenylenebisoxazoline and “D” is 1,4-phenylenebisoxazoline.

As examples of chain extenders bearing an imidazoline reactive function Y that are suitable for use in the invention, reference may be made to those described (“A” to “F”) on pages 7 to 8 and table 1 on page 10 of patent application EP 0 739 924, and also to the processes for preparing same and the modes of reaction thereof which are disclosed therein.

As examples of chain extenders bearing a reactive function Y=oxazinone or oxazolinone that are suitable for use in the invention, reference may be made to those described under references “A” to “D” on pages 7 to 8 of patent application EP 0 581 641, and also to the processes for preparing same and the modes of reaction thereof which are disclosed therein.

As examples of oxazinone (6-atom ring) and oxazolinone (5-atom ring) groups Y that are suitable, mention may be made of the groups Y derived from: benzoxazinone, oxazinone or oxazolinone, with, as spacer, A′ possibly being a single covalent bond with respective corresponding extenders being: bis (benzoxazinone), bisoxazinone and bisoxazolinone.

### Unit Z Bearing Amide Units

The unit Z bearing amide units is present in a molar content in the copolyamide ranging from 5% to 30%, preferentially from 10% to 25%.

It results from the condensation of at least one C6-C14 lactam or amino acid, or from the condensation of at least one diamine and at least one diacid X1Y, X1 and Y being C4-C18, in particular C10-C12.

When it results from the condensation of at least one C6-C14 lactam, said lactam is notably caprolactam, decanolactam, undecanolactam and lauryllactam.

Advantageously, said at least one lactam is C6-C12, more advantageously C10-C12.

When said unit Z is obtained from the polycondensation of at least one lactam, it may thus comprise a single lactam or several lactams.

Advantageously, said unit Z is obtained from the polycondensation of a single lactam and said lactam is chosen from lauryllactam and undecanolactam, advantageously undecanolactam.

When it results from the condensation of at least one C6-C14 amino acid, said at least one amino acid is notably 6-aminohexanoic acid, 9-aminononanoic acid, 10-aminodecanoic acid, 10-aminoundecanoic acid, 12-aminododecanoic acid and 11-aminoundecanoic acid and also derivatives thereof, notably N-heptyl-11-aminoundecanoic acid.

Advantageously, said at least one amino acid is C6-C12, more advantageously C10-C12.

When said at least one aliphatic semicrystalline polyamide is obtained from the polycondensation of at least one amino acid, it may thus comprise a single amino acid or several amino acids.

Advantageously, said unit Z is obtained from the polycondensation of a single amino acid and said amino acid is chosen from 11-aminoundecanoic acid and 12-aminododecanoic acid, advantageously 11-aminoundecanoic acid.

When said unit Z is obtained from the polycondensation of at least one diamine and at least one diacid X1Y, X1 and Y are C4-C36, notably C4-C18, in particular C10-C12.

Said at least one diamine X1 is an aliphatic diamine and said at least one diacid Y is an aliphatic diacid.

The diamine may be linear or branched. Advantageously, it is linear.

Said at least one C4-C36 diamine X1 may be chosen in particular from 1,4-butanediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and diamines obtained from fatty acids.

Advantageously, said at least one diamine X1 is C4-C18, and is chosen from 1,4-butanediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Advantageously, said at least one diamine X1 is C4-C12, and is chosen in particular from 1,4-butanediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine.

Advantageously, the diamine Ca used is C10-C12, and is in particular chosen from 1,10-decamethylenediamine, 1,11-undecamethylenediamine and 1,12-dodecamethylenediamine.

Said at least one C4-C36 dicarboxylic acid Y may be chosen from succinic acid, glutaric acid, adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, and diacids obtained from fatty acids.

The diacid may be linear or branched. Advantageously, it is linear.

Advantageously, said at least one dicarboxylic acid Y is notably C4-C18 and is chosen from adipic acid, suberic acid, azelaic acid, sebacic acid, undecanedioic acid, dodecanedioic acid, brassylic acid, tetradecanedioic acid, pentadecanedioic acid, hexadecanedioic acid and octadecanedioic acid.

Advantageously, said at least one dicarboxylic acid Y is notably C4-C12 and is chosen from adipic acid, suberic acid, azelaic acid, sebacic acid, undecanedioic acid and dodecanedioic acid.

Advantageously, said at least one dicarboxylic acid Y is notably C10-C12 and is chosen from sebacic acid, undecanedioic acid and dodecanedioic acid.

When said unit Z is obtained from the polycondensation of at least one diamine X1 with at least one dicarboxylic acid Y, it may thus comprise a single diamine or several diamines and a single dicarboxylic acid or several dicarboxylic acids.

Advantageously, said unit Z is obtained from the polycondensation of a single diamine X1 with a single dicarboxylic acid Y.

### Unit BACT Bearing Amide Units

BACT is a unit bearing an amide unit present in a molar content ranging from 10% to 65%, preferably from 10% to 60%, where BAC is 1,3-bis (aminomethyl) cyclohexyl (1,3-BAC), and T is terephthalic acid.

### Unit XT Bearing Amide Units

XT is a unit bearing an amide unit present in a molar content ranging from 30% to 60%, preferably from 35% to 55%, where X is a linear aliphatic C4 to C18 and preferably C5 to C12 diamine, in particular chosen from C5, C6, C10 and C12 and where T is terephthalic acid.

The C4 to C18 diamine X is as defined for the diamine X1.

The molar sum Z +BACT +XT is equal to 100%.

### Regarding the Flame Retardant

The flame retardant used has a thermal degradation onset temperature higher than the manufacturing temperature of a composite material comprising the reinforcing fiber composition of the present invention.

The flame retardant is present from 5% to 35% by weight and is either an at least partially meltable flame retardant in powder form and having a volume-mean diameter D50 of from 10 to 300 μm, notably from 10 to 200 μm, more particularly from 10 to 150 μm, or a non-meltable flame retardant in the form of a premilled powder with a volume-mean diameter D50 of from 1 to 50 μm, notably from 10 to 50 μm, more particularly from 15 to 25 μm, or a mixture thereof.

The volume diameters of the particles (D10, D50 and D90) are defined according to the standard ISO 9276:2014.

“D50” corresponds to the volume-mean diameter, that is to say the particle size value which divides the population of particles examined exactly into two.

“D90” corresponds to the value at 90% of the cumulative curve of the volume-based particle size distribution.

“D10” corresponds to the size of 10% of the volume of the particles.

The expression “at least partially meltable flame retardant” means that the flame retardant is at least partially molten at the implementation temperature of the composition, i.e. about 300° C.

As the flame retardant is at least partially meltable, the particle volume diameter D50 may be larger than with a non-meltable flame retardant, as the meltable flame retardant in the composition will enable long and/or continuous reinforcing fibers (fibrous material) to be preimpregnated in the solid state by the dry route with said composition, followed by the polymerization reaction of the composition, by heating said reactive composition and at least partial melting of said flame retardant, thus allowing good impregnation of the fibrous material with said composition.

Advantageously, the flame retardant is totally meltable at a temperature of less than about 300° C. or more.

The at least partially meltable flame retardant may be chosen from liquid phosphates such as triphenyl phosphates and tricresyl phosphate.

The term “non-meltable flame retardant” means that the flame retardant does not even partially melt at the implementation temperature of the composition, i.e. up to about 300° C.

Since the flame retardant is non-meltable, it is in the form of a premilled powder with a volume-mean diameter D50 of from 1 to 50 μm, notably from 10 to 50 μm, more particularly from 15 to 25 μm, and allows long and/or continuous reinforcing fibers (fibrous material) to be dry-preimpregnated in the solid state with said composition, followed by the polymerization reaction of the composition, by heating said reactive composition without melting said flame retardant which, due to its volume-mean diameter D50 of 1 to 50 μm, will still allow good impregnation of the fibrous material with said composition.

The non-meltable flame retardants may notably be a halogen-free flame retardant, as described in US 2008/0274355 and notably a phosphorus-based flame retardant, for example a metal salt chosen from a metal salt of phosphinic acid, in particular dialkyl phosphinate salts, notably diethylphosphinate aluminum salt or aluminum diethylphosphinate, a metal salt of diphosphinic acid, a mixture of an aluminum phosphinate flame retardant and a nitrogen synergist or a mixture of an aluminum phosphinate flame retardant and a phosphorus synergist, a polymer containing at least one metal salt of phosphinic acid, notably based on ammonium such as an ammonium polyphosphate, sulfamate or pentaborate, or based on cyanuric acid, or else a polymer containing at least one metal salt of diphosphinic acid or red phosphorus, an antimony oxide, a zinc oxide, an iron oxide, a magnesium oxide, boehmite or metal borates such as a zinc borate, or phosphazenes, a phospham or a phospho-oxynitride or a mixture thereof. The flame retardant fillers may also be halogenated flame retardants such as a brominated or polybrominated polystyrene, a brominated polycarbonate or a brominated phenol.

The flame retardant may be used alone or with a synergist, notably as described in WO 2005/121234.

### As Regards the Additive

Said at least one additive is present from 0 to 2% by weight in the composition relative to the total weight of constituents a), b) and c) of said composition.

Advantageously, it is present from 0.03% to 2.00% by weight in the composition relative to the total weight of constituents a), b) and c) of said composition.

Advantageously, it is present from 0.1% to 2% by weight in the composition relative to the total weight of constituents a), b) and c) of said composition.

It may be meltable or non-meltable.

The terms “meltable” and “non-meltable” have the same meaning here as for the flame retardants.

When non-meltable, it has a volume-mean diameter D50 of from 1 to 50 μm, notably from 10 to 50 μm, more particularly from 15 to 25 μm, and is in powder form.

When at least partially meltable, it has a volume-mean diameter D50 of from 10 to 300 μm, notably from 10 to 200 μm, more particularly from 10 to 150 μm if it is meltable.

Said additive may in particular be chosen from carbon-based fillers, in particular carbon black, or carbon-based nanofillers, preferably chosen from carbon-based nanofillers, in particular graphenes and/or carbon nanotubes and/or carbon nanofibrils, or mixtures thereof, a catalyst, an antioxidant, a thermal stabilizer, a UV stabilizer, a light stabilizer, a lubricant, a filler, a plasticizer, a flame retardant, a nucleating agent, a chain extender and a coloring agent or a mixture thereof.

As regards the Composition

The composition is obtained by dry blending of the various constituents a), b) and c).

The composition comprises:
a) from 65% to 95% by weight of at least one reactive semicrystalline polyamide prepolymer with an average molar mass Mn of less than 5000 g/mol and having a volume-mean diameter D50 of the reactive semicrystalline polyamide prepolymer powder particles of from 10 to 300 μm, notably from 30 to 200 μm, more particularly from 45 to 200 μm,
b) from 5% to 35% by weight of at least one flame retardant chosen from an at least partially meltable flame retardant and having a volume-mean diameter D50 of from 10 to 300 μm, notably from 10 to 200 μm, more particularly from 10 to 150 μm and a non-meltable flame retardant in premilled powder form and having a volume-mean diameter D50 of from 1 to 50 μm, notably from 10 to 50 μm, more particularly from 15 to 25 μm, and of a mixture of these, and
c) from 0% to 2% by weight of at least one additive and having a volume-mean diameter D50 of from 1 to 50 μm if it is non-meltable or from 10 to 300 μm if it is meltable,
the sum of the constituents a) +b) +c) being equal to 100% by weight.

In one embodiment, the composition consists of:
a) from 65% to 95% by weight of at least one reactive semicrystalline polyamide prepolymer with an average molar mass Mn of less than 5000 g/mol, as defined above,
b) from 5% to 35% by weight of at least one flame retardant as defined above, and
c) from 0% to 2% by weight of at least one additive, as defined above,
the sum of the constituents a) +b) +c) being equal to 100% by weight.

In another embodiment, the composition consists of:
a) from 65.00% to 94.97% by weight of at least one reactive semicrystalline polyamide prepolymer with an average molar mass Mn of less than 5000 g/mol, as defined above,
b) from 5.00% to 35.00% by weight of at least one flame retardant as defined above, and
c) from 0.03% to 2.00% by weight of at least one additive, as defined above,
the sum of the constituents a) +b) +c) being equal to 100% by weight.

In yet another embodiment, the composition consists of:
a) from 65% to 94.9% by weight of at least one reactive semicrystalline polyamide prepolymer with an average molar mass Mn of less than 5000 g/mol, as defined above,
b) from 5% to 35% by weight of at least one flame retardant as defined above, and
c) from 0.1% to 2% by weight of at least one additive, as defined above, the sum of the constituents a) +b) +c) being equal to 100% by weight.

In a first variant, said composition comprises:
a) from 65% to 90% by weight of at least one reactive semicrystalline polyamide prepolymer with an average molar mass Mn of less than 5000 g/mol, as defined above,
b) from 10% to 35% by weight of at least one flame retardant as defined above, and
c) from 0% to 2% by weight of at least one additive, as defined above,
the sum of the constituents a) +b) +c) being equal to 100% by weight.

In another embodiment of this first variant, said composition comprises:
a) from 65.00% to 89.97% by weight of at least one reactive semicrystalline polyamide prepolymer with an average molar mass Mn of less than 5000 g/mol, as defined above,
b) from 10.00% to 35.00% by weight of at least one flame retardant as defined above, and
c) from 0.03% to 2.00% by weight of at least one additive as defined above,
the sum of the constituents a) +b) +c) being equal to 100% by weight.

In yet another embodiment of this first variant, said composition comprises:
a) from 65% to 89.9% by weight of at least one reactive semicrystalline polyamide prepolymer with an average molar mass Mn of less than 5000 g/mol, as defined above,
b) from 10% to 35% by weight of at least one flame retardant as defined above, and
c) from 0.1% to 2% by weight of at least one additive as defined above,
the sum of the constituents a) +b) +c) being equal to 100% by weight.

In another embodiment of this first variant, said composition consists of:
a) from 65% to 90% by weight of at least one reactive semicrystalline polyamide prepolymer with an average molar mass Mn of less than 5000 g/mol, as defined above,
b) from 10% to 35% by weight of at least one flame retardant as defined above, and
c) from 0% to 2% by weight of at least one additive as defined above,
the sum of the constituents a) +b) +c) being equal to 100% by weight.

In another embodiment of this first variant, said composition consists of:
a) from 65.00% to 89.97% by weight of at least one reactive semicrystalline polyamide prepolymer with an average molar mass Mn of less than 5000 g/mol, as defined above,
b) from 10.00% to 35.00% by weight of at least one flame retardant as defined above, and
c) from 0.03% to 2.00% by weight of at least one additive as defined above.

In yet another embodiment of this first variant, said composition consists of:
a) from 65% to 89.9% by weight of at least one reactive semicrystalline polyamide prepolymer with an average molar mass Mn of less than 5000 g/mol, as defined above,
b) from 10% to 35% by weight of at least one flame retardant as defined above, and
c) from 0.1% to 2% by weight of at least one additive as defined above.

In a second variant, said composition comprises:
a) from 65% to 88% by weight of at least one reactive semicrystalline polyamide prepolymer with an average molar mass Mn of less than 5000 g/mol, as defined above,
b) from 12% to 35% by weight of at least one flame retardant as defined above, and
c) from 0% to 2% by weight of at least one additive as defined above,
the sum of the constituents a) +b) +c) being equal to 100% by weight.

In another embodiment of this second variant, said composition comprises:
a) from 65.00% to 87.97% by weight of at least one reactive semicrystalline polyamide prepolymer with an average molar mass Mn of less than 5000 g/mol, as defined above,
b) from 12.00% to 35.00% by weight of at least one flame retardant as defined above, and
c) from 0.03% to 2.00% by weight of at least one additive as defined above,
the sum of the constituents a) +b) +c) being equal to 100% by weight.

In yet another embodiment of this second variant, said composition comprises:
a) from 65% to 87.9% by weight of at least one reactive semicrystalline polyamide prepolymer with an average molar mass Mn of less than 5000 g/mol, as defined above,
b) from 12% to 35% by weight of at least one flame retardant as defined above, and
c) from 0.1% to 2% by weight of at least one additive as defined above,
the sum of the constituents a) +b) +c) being equal to 100% by weight.

In another embodiment of this second variant, said composition consists of:
a) from 65% to 88% by weight of at least one reactive semicrystalline polyamide prepolymer with an average molar mass Mn of less than 5000 g/mol, as defined above,
b) from 12% to 35% by weight of at least one flame retardant as defined above, and
c) from 0% to 2% by weight of at least one additive as defined above,
the sum of the constituents a) +b) +c) being equal to 100% by weight.

In yet another embodiment of this second variant, said composition consists of:
a) from 65.00% to 87.97% by weight of at least one reactive semicrystalline polyamide prepolymer with an average molar mass Mn of less than 5000 g/mol, as defined above,
b) from 12.00% to 35.00% by weight of at least one flame retardant as defined above, and
c) from 0.03% to 2.00% by weight of at least one additive as defined above,
the sum of the constituents a) +b) +c) being equal to 100% by weight.

In another embodiment of this second variant, said composition consists of:
a) from 65% to 87.9% by weight of at least one reactive semicrystalline polyamide prepolymer with an average molar mass Mn of less than 5000 g/mol, as defined above,
b) from 12% to 35% by weight of at least one flame retardant as defined above, and
c) from 0.1% to 2% by weight of at least one additive as defined above,
the sum of the constituents a) +b) +c) being equal to 100% by weight.

In a third variant, said composition comprises:
a) from 65% to 85% by weight of at least one reactive semicrystalline polyamide prepolymer with an average molar mass Mn of less than 5000 g/mol, as defined above,
b) from 15% to 35% by weight of at least one flame retardant as defined above, and
c) from 0% to 2% by weight of at least one additive as defined above,
the sum of the constituents a) +b) +c) being equal to 100% by weight.

In another embodiment of this third variant, said composition comprises:
a) from 65.00% to 84.97% by weight of at least one reactive semicrystalline polyamide prepolymer with an average molar mass Mn of less than 5000 g/mol, as defined above,
b) from 15.00% to 35.00% by weight of at least one flame retardant as defined above, and
c) from 0.03% to 2.00% by weight of at least one additive, as defined above,
the sum of the constituents a) +b) +c) being equal to 100% by weight.

In yet another embodiment of this third variant, said composition comprises:
a) from 65% to 84.9% by weight of at least one reactive semicrystalline polyamide prepolymer with an average molar mass Mn of less than 5000 g/mol, as defined above,
b) from 15% to 35% by weight of at least one flame retardant as defined above, and
c) from 0.1% to 2% by weight of at least one additive, as defined above,
the sum of the constituents a) +b) +c) being equal to 100% by weight.

In another embodiment of this third variant, said composition consists of:
a) from 65% to 85% by weight of at least one reactive semicrystalline polyamide prepolymer with an average molar mass Mn of less than 5000 g/mol, as defined above,
b) from 15% to 35% by weight of at least one flame retardant as defined above, and
c) from 0% to 2% by weight of at least one additive as defined above,
the sum of the constituents a) +b) +c) being equal to 100% by weight.

In yet another embodiment of this third variant, said composition consists of:
a) from 65.00% to 84.97% by weight of at least one reactive semicrystalline polyamide prepolymer with an average molar mass Mn of less than 5000 g/mol, as defined above,
b) from 15.00% to 35.00% by weight of at least one flame retardant as defined above, and
c) from 0.03% to 2.00% by weight of at least one additive as defined above,
the sum of the constituents a) +b) +c) being equal to 100% by weight.

In another embodiment of this third variant, said composition consists of:
a) from 65% to 84.9% by weight of at least one reactive semicrystalline polyamide prepolymer with an average molar mass Mn of less than 5000 g/mol, as defined above,
b) from 15% to 35% by weight of at least one flame retardant as defined above, and
c) from 0.1% to 2% by weight of at least one additive as defined above,
the sum of the constituents a) +b) +c) being equal to 100% by weight.

Advantageously, in the embodiments of one of the three variants, XT is chosen from 5T, 6T, 10T and 12T, more preferentially 5T, 6T and 10T.

5 corresponding to 1,5-pentamethylenediamine, 6 corresponding to 1,6-hexamethylenediamine, 10 corresponding to 1,10-decamethylenediamine, and 12 corresponding to 1,12-dodecamethylenediamine.

More advantageously, in the embodiments of one of the three variants, XT is 10T, 10 corresponding to 1,10-decamethylenediamine.

Even more advantageously, in the embodiments of one of the three variants, Z results from the condensation of a C11 amino acid.

In particular, in the embodiments of one of the three variants, XT is chosen from 5T, 6T, 10T and 12T, more preferentially 5T, 6T and 10T, and Z results from condensation of a C11 amino acid.

In particular, in the embodiments of one of the three variants, XT is 10T, 10 corresponding to 1,10-decanediamine and Z results from condensation of a C11 amino acid.

The composition is prepared by “dry blending” before introduction into the preimpregnation tank or by “dry blending” carried out directly in the tank of the various constituents thereof, that is to say the prepolymer, the flame retardant and the additive or additives. Said tank is the equipment used for performing the preimpregnation, notably by fluidized bed. Preferably, the blending is carried out in a rapid mixer before introduction into the impregnation tank.

According to another aspect, the present invention relates to the use of a reactive composition as defined above, for the preparation of a flame-retardant composite fibrous material, said fibrous material comprising from 30% to 60% by volume, preferentially 35% to 50% by volume, of said composition and from 40% to 70% by volume, preferentially 50% to 65% by volume, of long and/or continuous reinforcing fibers.

As Regards the Long and/or Continuous Reinforcing Fibers

The reinforcing fibers or fibrous reinforcement may be an assembly of long and/or continuous fibers, preferably of continuous fibers, i.e. fibers having an aspect ratio defined by the ratio of length to diameter of the fiber, which means that these fibers have a circular cross-section, greater than 1000, preferably greater than 2000. In this assembly, the fibers may be long and/or continuous, in the form of a unidirectional (UD) or multidirectional (2D, 3D) reinforcer. In particular, they may be in the form of fabrics, sheets, strips or braids and may also be cut, for example in the form of nonwovens (mats) or in the form of felts.

These reinforcing fibers may be chosen from:
mineral fibers, said fibers having high melting temperatures Tf′ above the melting temperature Tf of said semicrystalline polyamide of the invention and above the polymerization and/or processing temperature;
polymeric fibers or polymer fibers having a melting temperature Tf′, or if not Tf′, a glass transition temperature Tg′, above the polymerization temperature or above the melting temperature Tf of said semicrystalline polyamide constituting said matrix of the composite and above the processing temperature;
or mixtures of the abovementioned fibers.

As mineral fibers that are suitable for use in the invention, mention may be made of carbon fibers, which include fibers of nanotubes or carbon nanotubes (CNTs), carbon nanofibers or graphenes; silica fibers such as glass fibers, in particular of E, R or S2 type; boron fibers; ceramic fibers, in particular silicon carbide fibers, boron carbide fibers, boron carbonitride fibers, silicon nitride fibers, boron nitride fibers, basalt or basalt-based fibers; fibers or filaments based on metals and/or alloys thereof; fibers of metal oxides, in particular of alumina (Al2O3); metallized fibers such as metallized glass fibers and metallized carbon fibers, or mixtures of the abovementioned fibers.

More particularly, these fibers may be chosen as follows:
the mineral fibers may be chosen from: carbon fibers, carbon nanotube fibers, glass fibers, in particular of E, R or S2 type; boron fibers, ceramic fibers, in particular silicon carbide fibers, boron carbide fibers, boron carbonitride fibers, silicon nitride fibers, boron nitride fibers, basalt fibers, fibers or filaments based on metals and/or alloys thereof, fibers based on metal oxides such as Al2O3, metallized fibers such as metallized glass fibers and metallized carbon fibers, or mixtures of the abovementioned fibers, and
the polymer fibers or polymeric fibers, under the abovementioned condition, are chosen from:
fibers of thermosetting polymers and more particularly those chosen from: unsaturated polyesters, epoxy resins, vinyl esters, phenolic resins, polyurethanes, cyanoacrylates and polyimides, such as bismaleimide resins, or aminoplasts resulting from the reaction of an amine such as melamine with an aldehyde such as glyoxal or formaldehyde,
thermoplastic polymer fibers, more particularly chosen from: polyethylene terephthalate (PET), polybutylene terephthalate (PBT), high-density polyolefins such as polyethylene (PE), polypropylene (PP) and PE/PP, PVOH (polyvinyl alcohol) copolymers,
fibers of polyamides corresponding to one of the formulae: 6, 11, 12, 6.10, 6.12, 6.6 and 4.6,
fibers of aramids (such as Kevlar®) and aromatic polyamides such as those corresponding to one of the formulae: PPD.T, MPD.I, PAA and PPA, with PPD and MPD being, respectively, p- and m-phenylenediamine, PAA being polyarylamides and PPA being polyphthalamides,
fibers of polyamide block copolymers such as polyamide/polyether, fibers of polyaryl ether ketones (PAEKs) such as polyether ether ketone (PEEK), polyether ketone ketone (PEKK) or polyether ketone ether ketone ketone (PEKEKK).

The preferred reinforcing fibers are continuous fibers (with a circular cross-section) chosen from: carbon fibers, including those which are metallized, glass fibers, including those which are metallized, of E, R, S2 type, aramid fibers (such as Kevlar®) or aromatic polyamides, polyaryl ether ketone (PAEK) fibers, such as polyether ether ketone (PEEK) fibers, polyether ketone ketone (PEKK) fibers, polyether ketone ether ketone ketone (PEKEKK) fibers, or mixtures thereof.

The fibers that are more particularly preferred are chosen from: glass fibers, carbon fibers, ceramic fibers and aramid fibers (such as Kevlar®), or mixtures thereof. These fibers have a circular cross-section.

In one embodiment, the long and/or continuous reinforcing fibers are in particular circular in cross-section with L/D>1000, preferably >2000 and more particularly chosen from glass, carbon, basalt, ceramic and aramid fibers or mixtures thereof.

L/D corresponds to the aspect ratio defined by the ratio of length (L) to diameter (D) of the fiber, which means that these fibers have a circular cross-section with L/D greater than 1000, preferably greater than 2000.

According to another aspect, the present invention relates to a process for manufacturing a flame-retardant thermoplastic composite material, in particular a mechanical or structural part based on said material, characterized in that it comprises at least one step of polymerizing at least one composition as defined above.

In one embodiment, said process comprises the following steps:
a) dry solid-state preimpregnation of long and/or continuous reinforcing fibers with a composition as defined above,
b) polymerization reaction of the composition, by heating said reactive composition with chain extension, as the case may be, by polycondensation reaction or by polyaddition reaction, in the molten mass state,
c) optionally, processing by molding or another processing system, simultaneously with the polymerization step b).

The preimpregnation may be performed by powder deposition, by fluidized bed, optionally equipped with at least one loading device (E′), or by dry spraying by nozzle or gun into a tank, optionally equipped with at least one feeding device (E′).

These various processes are described in WO 2018/234436.

The composition used for the preimpregnation is obtained by “dry blending” before introduction into the preimpregnation tank or by “dry blending” carried out directly in the tank of the various constituents thereof, that is to say the prepolymer, the flame retardant and the additive or additives.

The polymerization is performed by passing the preimpregnated reinforcing fibers through a heating system provided with at least one feeding part as described in WO 2018/234436 or WO 2018/234439 or WO 2018/234434.

According to another aspect, the present invention relates to a thermoplastic composite material characterized in that it comprises from 30% to 60% by volume, preferentially 35% to 50% by volume, of said reactive composition as defined above, polymerized, and from 40% to 70% by volume, preferentially 50% to 65% by volume, of long and/or continuous reinforcing fibers.

According to yet another aspect, the present invention relates to a mechanical or structural part of a thermoplastic composite material, characterized in that it is based on a composite material as defined above.

Advantageously, said mechanical part is a motor vehicle part post-treated by cataphoresis.

Advantageously, said mechanical part is a motor vehicle metal/composite hybrid part.

Advantageously, said mechanical part is a part for the wind power sector.

Advantageously, said mechanical part is a part for the aeronautical sector.

Advantageously, said mechanical part is a part for the railway sector.

### EXAMPLES

### Example 1: Preparation of Compositions According to the Invention

Compositions 11 to C1 below were prepared by dry blending:

Preparation of a prepolymer with an Mn of less than 5000 g/mol:

The following procedure is an example of a preparation process, and is not limiting. It is representative of all the prepolymers prepared:
5 kg of the following starting materials are introduced into a 14-liter autoclave reactor:
500 g of water,
the diamines,
the amino acid or the lactam (optionally),
the terephthalic acid and optionally one or more other diacids,
optionally a monofunctional chain regulator: benzoic acid, in an amount suitable for the targeted Mn and ranging (benzoic acid) from 50 to 100 g,
35 g of sodium hypophosphite in solution,
0.1 g of an antifoaming agent, Wacker AK1000 (from the company Wacker Silicones).

The closed reactor is purged of its residual oxygen and then heated to a material temperature of 280° C. After stirring for 30 minutes under these conditions, the pressurized vapor which has formed in the reactor is gradually reduced in pressure over 60 minutes, while gradually increasing the material temperature so that it becomes established at Tf +10° C. at atmospheric pressure.

To obtain the prepolymer with an Mn of less than 5000 g/mol, the pressure reduction has to be stopped at approximately 15 bar or have greatly limited the polymer to stop its growth with a chain regulator.

The polymer or oligomer (prepolymer) is subsequently emptied out via the bottom valve, then cooled in a water tank and chopped into granules from 1 to 5 millimeters in diameter.

The prepolymer granules with an Mn of less than 5000 g/mol are then milled (or micronized) to the desired powder size using a CUM 150 impact mill from the company Netzsch, equipped with pin disks.

### Preparation of the Composition

After having stirred the various constituents of the dry ingredients composition (prepolymer milled to the desired volume diameter D50, flame retardant and optionally additives milled to the desired volume diameter D50 according to whether they are meltable or non-meltable) for several minutes in order to ensure good bulk blending, the blends were dried in a circulating air oven with hot air at 80°° C. for 16 hours and subsequently rapidly placed in airtight containers.

For the comparative composition C2, it was attempted to prepare it by compounding according to the following procedure:

Preparation of a prepolymer with an Mn of less than 5000 g/mol:

5 kg of the following starting materials are introduced into a 14-liter autoclave reactor:
5-500 g of water,
the diamines,
the amino acid or the lactam (optionally),
the terephthalic acid and optionally one or more other diacids,
optionally a monofunctional chain regulator: benzoic acid, in an amount suitable for the targeted Mn and ranging (benzoic acid) from 50 to 100 g,
35 g of sodium hypophosphite in solution,
0.1 g of an antifoaming agent, Wacker AK1000 (from the company Wacker Silicones).

The closed reactor is purged of its residual oxygen and then heated to a material temperature of 280°° C. After stirring for 30 minutes under these conditions, the pressurized vapor which has formed in the reactor is gradually reduced in pressure over 60 minutes, while gradually increasing the material temperature so that it becomes established at Tf +10° C. at atmospheric pressure.

To obtain the prepolymer with an Mn of 5000 g/mol, the pressure reduction has to be stopped at approximately 15 bar or have greatly limited the polymer to stop its growth with a chain regulator.

The polymer or oligomer (prepolymer) is subsequently emptied out via the bottom valve, then cooled in a water tank and chopped into granules.

The prepolymer granules, with an Mn of less than 5000 g/mol, are then fed into a twin-screw extruder, together with the flame retardant and, if required, the additive. This composition C2 was impossible to prepare by compounding. Specifically, after 5 minutes of compounding, the mixture began to degrade, this being reflected by increased expansion of the rod, increased pressure, lower torque and, above all, the increasing presence of smoke in the die. The melt temperature measured at 305° C., the viscosification of the medium linked to the reaction between the flame retardant and the prepolymer of the invention causes excessive self-heating.

TABLE 1

| C1 Dry-blend | I1 Dry-blend | C2 Compounding |
|---|---|---|
| 11/BACT/10T of | 11/BACT/10T of | 11/BACT/10T |
| Mn 2500 | Mn 2500 | of Mn 2500 |
| (80% by weight) | (80% by weight) | (80% by weight) |
| Aflammit PCO | Exolit OP 1230 | Aflammit (20% |
| 900 | (D50: 20-40 μm) | by weight) |
| D50: 3 μm) | (20% by weight) | D50: 3 μm |
| (20% by weight) | | |

Exolit OP 1230 (melting point>300° C. (decomposition)) is sold by Clariant and Aflammit PCO 900 (melting point: 245° C.) is sold by Thor.

1,3 BAC with a cis/trans ratio of 75/25 mol % is sold by Mitsubishi Gas Chemicals.

The prepolymer (11/BACT/10T) used as dry blend for compositions 11 and C1 is prepared and then milled (D10/D50/D90: 22/81/176 μm).

### Example 2: Compositions I1 and C1 Were Tested Using a Commonly Practised Flame Propagation Test Named UL94 in Accordance With the Standard NFT 51072 and Performed in 1.6 mm Thick Test Specimens

The results are shown in table 2.

TABLE 2

| | Observation | Classification |
|---|---|---|
| I1 | No flame Test specimen deformed and carbonized | V-0 |
| C1 | No flame, but the product liquefies and forms non- | V-2 |
| | ignited droplets | |

1. A flame-retardant reactive composition for a flame-retardant thermoplastic composite material comprising:
a) from 65% to 95% by weight of at least one reactive semicrystalline polyamide prepolymer with an average molar mass Mn of less than 5000 g/mol, as determined by calculation from the content of end functions determined by potentiometric titration in solution and the functionality of said prepolymers or by NMR assay and having a volume-mean diameter D50 of the reactive semicrystalline polyamide prepolymer powder particles of from 10 to 300 μm, notably from 30 to 200 μm,
the volume-mean diameter D50 being determined according to the standard ISO 9276:2014,
said reactive semicrystalline polyamide prepolymer meaning that the molecular weight of said reactive semicrystalline polyamide prepolymer will change during its subsequent implementation by reaction of reactive semicrystalline polyamide prepolymers with each other by polycondensation with the release of water or by substitution or by reaction of reactive prepolymers with a chain extender by polyaddition and without elimination of volatile byproducts to subsequently lead, after implementation, to the final nonreactive semicrystalline polyamide polymer of the thermoplastic matrix,
b) from 5% to 35% by weight of at least one flame retardant chosen from an at least partially meltable flame retardant in powder form and having a volume-mean diameter D50 of from 10 to 300 μm, and a non-meltable flame retardant in premilled powder form with a volume-mean diameter D50 of from 1 to 50 μm,
an at least partially meltable flame retardant meaning that the flame retardant is at least partially molten at the implementation temperature of the composition, i.e. about 300° C., and
c) from 0% to 2% by weight of at least one additive and having a volume-mean diameter D50 of from 1 to 50 μm if it is non-meltable or from 10 to 300 μm if it is meltable,
said composition being obtained by dry blending of the various constituents a), b) and c),
a non-meltable flame retardant meaning that the flame retardant does not even partially melt at the implementation temperature of the composition, i.e. up to about 300° C., and
said reactive polyamide prepolymer comprising or consisting of at least one Z/BACT/XT copolyamide in which:
BACT is a unit bearing an amide unit present in a molar content ranging from 10% to 65%, where BAC is 1,3-bis (aminomethyl) cyclohexyl (1,3-BAC), and T is terephthalic acid,
XT is a unit bearing an amide unit present in a molar content ranging from 30% to 60%, where X is a linear aliphatic C4 to C18 and where T is terephthalic acid,
Z is a unit bearing an amide unit present in a molar content ranging from 5% to 30%, and resulting:
from the condensation of at least one C6-C14 amino acid or lactam, or
from the condensation of at least one diamine X1 and of at least one diacid Y, X1 and Y being of C4-C36, notably C4-C18,
the molar sum Z+BACT+XT being equal to 100%, and the sum of constituents a)+b)+c) being equal to 100% by weight, said reactive semicrystalline polyamide prepolymer having a melting temperature Tf<300° C., as determined according to the standard ISO 11357-3:2013, a glass transition temperature Tg>80° C., determined according to the standard ISO 11357-2:2013 and a difference between the melting temperature and the crystallization temperature Tf—Tc<70° C., determined according to the standard ISO 11357-3:2013.

2. The reactive composition as claimed in claim 1, wherein the heat of crystallization of the semicrystalline polyamide polymer, measured by differential scanning calorimetry (DSC) according to the standard ISO 11357-3:2013, is greater than 25 J/g.

3. The reactive composition as claimed in claim 1, wherein XT is chosen from 5T, 6T, 10T and 12T, 5 corresponding to 1,5-pentamethylenediamine, 6 corresponding to 1,6-hexamethylenediamine, 10 corresponding to 1,10-decamethylenediamine, and 12 corresponding to 1,12-dodecamethylenediamine, and T corresponding to terephthalic acid.

4. The reactive composition as claimed in claim 1, wherein XT is 10T, 10 corresponding to 1,10-decamethylenediamine.

5. The reactive composition as claimed in claim 1, wherein Z results from the (poly) condensation of a C11 amino acid.

6. The reactive composition as claimed in claim 1 wherein the reactive semicrystalline polyamide prepolymer comprises or consists of at least one reactive prepolymer bearing, on the same chain, two end functions X′ and Y′, said functions being respectively coreactive with each other by condensation, with X′ and Y′ being amine and carboxyl or carboxyl and amine, respectively.

7. The reactive composition as claimed in claim 1, wherein said reactive semicrystalline polyamide prepolymer comprises at least two polyamide prepolymers which are reactive with each other and which each respectively bear two identical end functions X′ or Y′, said function X′ of one prepolymer being able to react only with said function Y′ of the other prepolymer.

8. The reactive composition as claimed in claim 1, wherein said reactive semicrystalline polyamide prepolymer comprises or consists of:
a1) at least one prepolymer of said thermoplastic polyamide polymer, bearing n end reactive functions X′, chosen from: —NH2,—CO2H and —OH, with n being from 1 to 3,
a2) at least one chain extender Y—A′—Y, with A′ being a hydrocarbon-based biradical of nonpolymeric structure, bearing two identical end reactive functions Y, which are reactive by polyaddition with at least one function X′ of said prepolymer a1).

9. The reactive composition as claimed in claim 8, wherein X′ is NH2 or OH, and Y is chosen from an anhydride, a maleimide, an optionally blocked isocyanate, an oxazinone, an oxazolinone and an epoxy, and notably from an anhydride.

10. The reactive composition as claimed in claim 8, wherein it comprises a1) at least one amino prepolymer (bearing —NH2) of said semicrystalline polyamide polymer of the thermoplastic matrix, and a2) at least one non-polymeric chain extender bearing a cyclic carboxylic anhydride group, having as substituent a group comprising an ethylenic or acetylenic unsaturation, said carboxylic anhydride group possibly being in acid, ester, amide or imide form with said extender a2) being present in a content corresponding to an a2)/(—NH2) mole ratio of less than 0.36, and wherein said thermoplastic polymer of the matrix is the product of the polymerization reaction by extension of said prepolymer a1) by said extender a2).

11. The reactive composition as claimed in claim 10, wherein said extender a2) is chosen from aromatic anhydride compounds, substituted, in position 4 of the aromatic ring, with a substituent defined by a group R—C═C—(R′)x— with R being a C1-C2 alkyl or H or aryl, or R is the residue of an aromatic carboxylic anhydride, bonded to the acetylenic triple bond via the carbon in position 4 of the aromatic ring and x being equal to 0 or to 1, and when x is equal to 1, R′ is a carbonyl group.

12. The reactive composition as claimed in claim 10, wherein said extender a2) is chosen from o-phthalic aromatic anhydride compounds bearing, in position 4, a substituent group chosen from methyl ethynyl, phenyl ethynyl, 4-(o-phthaloyl) ethynyl or phenyl ethynyl ketone, also called (phenylethynyl) trimellitic anhydride.

13. The reactive composition as claimed in one of claim 10, wherein said extender a2) has a molecular weight of less than or equal to 500 g/mol.

14. The reactive composition as claimed in claim 8, wherein X′ is CO2H and Y is chosen from an epoxy, an oxazoline, an oxazine, an imidazoline and an aziridine, such as 1,1′-iso- or terephthaloyl bis (2-methylaziridine), notably an epoxy and an oxazoline.

15. The reactive composition as claimed in claim 14, wherein X′ is CO2H and Y—A′—Y is chosen from phenylenebisoxazolines.

16. The use of a reactive composition as defined in claim 1, for the preparation of a flame-retardant composite fibrous material, said fibrous material comprising from 30% to 60% by volume, of said composition and from 40% to 70% by volume, of long and/or continuous reinforcing fibers.

17. The use of a reactive composition as claimed in claim 16, wherein the long and/or continuous reinforcing fibers have a circular cross-section with L/D>1000.

18. A process for manufacturing a flame-retardant thermoplastic composite material, wherein it comprises at least one step of polymerizing at least one composition as defined in claim 1.

19. The process as claimed in claim 18, wherein it comprises the following steps:
a) dry solid-state preimpregnation of long and/or continuous reinforcing fibers with a the at least one composition,
b) polymerization reaction of the composition, by heating said reactive composition with chain extension, as the case may be, by polycondensation reaction or by polyaddition reaction, in the molten mass state,
c) optionally, processing by molding or another processing system, simultaneously with the polymerization step b).

20. A thermoplastic composite material wherein it comprises from 30% to 60% by volume, of said reactive composition as defined in claim 1, polymerized, and from 40% to 70% by volume, of long and/or continuous reinforcing fibers.

21. A mechanical or structural part of a thermoplastic composite material, wherein it is based on a composite material as defined in claim

20.

22. The mechanical or structural part as claimed in claim 21, wherein it is a motor vehicle part post-treated by cataphoresis.

23. The mechanical or structural part as claimed in claim 21, wherein it is a motor vehicle metal/composite hybrid part.

24. The mechanical or structural part as claimed in claim 21, wherein it is a part for the wind power sector.

25. The mechanical or structural part as claimed in claim 21, wherein it is a part for the aeronautical sector.

26. The mechanical or structural part as claimed in claim 21, wherein it is a part for the railway sector.
